(19) United States
(12) Patent Application Publication
(10) Pub. No.: US 2025/0075765 A1
(43) Pub. Date: Mar. 6, 2025

(54) ABSORBER DEVICE AND DAMPER DEVICE

(71) Applicants: Technische Universität Darmstadt, Darmstadt (DE); Industrial Science GmbH powered by IAV, Darmstadt (DE)

(72) Inventors: Nicolas BRÖTZ, Darmstadt (DE); Peter PELZ, Darmstadt (DE); Ingo DIETRICH, Ingelheim (DE)

(73) Assignees: Technische Universität Darmstadt, Darmstadt (DE); Industrial Science GmbH powered by IAV, Darmstadt (DE)

(21) Appl. No.: 18/726,372

(22) PCT Filed: Jan. 10, 2023
(86) PCT No.: PCT/EP2023/050474

§ 371 Date: Jul. 2, 2024

(30) Foreign Application Priority Data
Jan. 10, 2022 (DE) 10 2022 100 397.3

(51) Int. Cl. F16F 7/104; B60G 13/18

(52) U.S. Cl. CPC F16F 7/104; B60G 13/18; B60G 2202/25; B60G 2204/62; B60G 2500/104; B60G 2600/21; B60G 2800/162; B60G 2800/916; F16F 2222/08; F16F 2222/12; F16F 2224/04; F16F 2228/12; F16F 2230/30

(57) ABSTRACT

An absorber device for absorbing a force acting thereon includes an absorber housing which encloses an interior space and a hydraulic medium arranged in the interior space. An absorber piston rod has an absorber piston arranged thereon. The absorber piston divides the interior space into a first chamber and a second chamber. The absorber piston rod has a spring device for resiliently supporting the absorber piston relative to a quasi-static component. The absorber piston is mounted axially movably on the absorber piston rod. A first spring and a second spring of the spring device are arranged in each case on both sides of the absorber piston and resiliently connect the absorber piston rod to the absorber piston and counteract a movement of the absorber piston in the axial direction, relative to the absorber piston rod. The absorber device can be arranged in a hollow damper piston rod of a damper.

### CROSS-REFERENCE TO RELATED APPLICATION

This application is a national stage application, filed under 35 U.S.C. § 371, of International Patent Application PCT/EP2023/050474, filed on Jan. 10, 2023, which claims the benefit of German Patent Application DE 10 2022 100 397.3, filed on Jan. 10, 2022.

### BACKGROUND

Absorber devices are used in varied manners in the technical field of installations and systems. Wherever damage, production loss, or even failure of a component may occur on account of jolts and vibrations, these undesired vibrations can be reduced with the aid of suitably designed absorber devices, wherein damage can be prevented or meaningful operation of a component is made possible only by the reduction in the vibration.

Absorber devices are used for example in the automotive industry, in the case of vibratory components in motor vehicles. In this case, they are used in particular in vibration optimization and in the reduction of vibrations of a vehicle body relative to the wheels, in order to as far as possible isolate the vehicle body from the wheels, in terms of vibration technology. When travelling over unevenness, a suspension of the motor vehicle absorbs the acting jolts, deforms, and then relaxes again, outputting the energy. A temporally quick sequence of these processes results in undesired vibrations. These vibrations should be reduced by the absorber device, in order that they are not transferred to the vehicle body and ultimately the occupants. In addition to this advantage in terms of comfort technology, this also increases the safety of the motor vehicle, due to the improved roadholding.

A possibility for reducing these vibrations consists in displacing the occurring energy, in order to counteract a resonance of the vibratory component, for example the unsprung mass of the wheel or of the vehicle body, in the natural frequency. In this case, absorber devices consist, in practice, of a spring device/mass system. In this case the inert mass of the absorber device, also referred to as the inertia, is connected to the vibratory component via the spring device, and the absorber device is matched to a natural frequency or the resonant frequency, to be eliminated, of the vibratory component. In the range of the natural frequency of the absorber, the inert mass vibrates counter to the excitation of the vibratory component, which results in an excessive increase in the force, or in this case the stiffness. Therefore, at this frequency, during use of an absorber device matched thereto, smaller movements triggered by the vibrations occur, wherein the generation of vibrations of the absorber device withdraws energy from the vibratory component. The necessary and sometimes complex matching means that absorber devices are usually only used in situations in which the framework conditions are precisely known, for example in series production or in the case of complex and costly production of custom-made items.

In the case of motor vehicles, the reduction of the vibrations is a compromise between absorbing the vibrations at low speeds for stabilizing the vehicle body, and reduction in the case of high speeds, caused by jerky excitations. Although too great a reduction at low speeds leads to improved control of the vehicle body, at high speeds this can lead to harsh travel. Three fundamental possibilities are known from practice, as to how the occurring vibrations can be reduced.

Firstly, passive absorber devices, like the combination, discussed above, of an inertia connected to the vibratory component via a spring device, are known. The passive absorber devices also include for example what are known as inerters, which have found their way into motor car construction under the term “J-damper” (M. Chen, C. Papageorgiou, F. Scheibe, F.-c. Wang, M. Smith, The missing mechanical circuit element, 2009, IEEE Circuits Syst. Mag. 9, 10-26). In addition, semi-active absorber devices are known, in which an aperture can be adjusted in order to be able to adapt the absorption, wherein, however, a complex energy supply and regulation technology is required. Furthermore, the reduction of the vibration can also take place in a frequency-dependent manner, wherein the inertia is used to engage and disengage the damping in a frequency-dependent manner. Active absorber devices known from practice, just as semi-active absorber devices, additionally require complex regulation technology, and are therefore complex to produce as well as costly compared with passive systems.

Depending on the application or depending on the resonance frequency of the vibratory system that is to be absorbed, a heavy and thus large inertia may be necessary. However, this must absolutely be prevented, in particular in the case of lightweight construction applications, as are used in the automotive industry, in order to design the motor vehicles to be as lightweight as possible and in the process as environmentally friendly as possible, due to the associated lower petrol or diesel consumption. This weight problem can be reduced by coupling a known spring device/mass system to a hydraulic transmission. The mass can be designed to be lighter, due to the hydraulic transmission. The mass or the inertia can be increased in that a hydraulic medium is pressed from a chamber having a larger cross-section, via a pressure compensation device having a smaller cross-section, into a further chamber. The inertia can be specified by the dimensioning of these two chambers and the pressure compensation device. A prerequisite for this is that the absorber device, in addition to the connection to the vibratory component, additionally comprises a connection to a quasi-static component. In the case of a motor vehicle, for example the vibratory component can be one of the wheels, and the quasi-static component can be the vehicle body. However, it is disadvantageous that this variant allows only a small deflection depth of a chassis, which is necessary, however, in order that the chassis can deflect in the case of an uneven substrate, in order to allow for smooth and comfortable travel. Furthermore, an embodiment of this kind can barely absorb transverse forces, by the connection via a spring device, as said forces can occur in the case of cornering for example (N. Brötz, P. F. Pelz, Bayesian Uncertainty Quantification in the Development of a New Vibration Absorber Technology, in Z. Ma (Ed.), Model Validation and Uncertainty Quantification, Volume 3, Springer International Publishing, Cham, 2020, 19-26).

From the prior art, a combination of a hydraulic transmission and a spring device is known, which are connected one behind the other along an axial direction and can absorb transverse forces in the process. For this purpose, the absorber device comprises an absorber housing, which encloses an interior space, wherein an absorber piston and an absorber piston rod connected to the absorber piston are arranged in the interior space. The absorber piston rod protrudes out of the interior space and is connected to the spring device. In this embodiment, the absorber piston rod can be arranged on the quasi-static component and the absorber housing on the vibratory component. In the event of action of a force on the absorber piston rod along the axial direction, a movement of the absorber piston rod along the axial direction, relative to the absorber housing, can be made possible (N. Brötz, P. Hedrich, P. F. Pelz, Integrated Fluid Dynamic Vibration Absorber for Mobile Applications, in: 11th International Fluid Power Conference (11th IFK), Aachen, 2018, 14-25). Although the hydraulic connection makes it possible for the required mass for the respective task to be designed to be as light as possible, an embodiment of this kind has, due to the spring device and the hydraulic transmission being connected one behind the other, a large space requirement, in particular in the axial direction.

### SUMMARY

The disclosure relates to an absorber device for absorbing a force acting on an absorber device. The absorber device comprises an absorber housing, which encloses an interior space and has a hydraulic medium arranged in the interior space, and comprises an absorber piston rod, which has an absorber piston arranged thereon. The absorber piston rod is arranged so as to protrude into the interior space along an axial direction relative to the absorber housing. The absorber piston is arranged in the interior space and divides said interior space into a first chamber and a second chamber. The absorber piston rod comprises a spring device for resiliently supporting the absorber piston rod relative to a quasi-stationary component, such that in the event of action of a force on the absorber piston rod along the axial direction, with a force greater than a spring force of the spring device, a movement of the absorber piston rod along the axial direction, relative to the absorber housing, is made possible. Upon movement of the absorber piston rod the absorber piston is moved and a pressure is applied to the hydraulic medium of the second chamber by the absorber piston, and the pressure is compensated via a hydraulic medium-conducting pressure compensation device that connects the second chamber to the first chamber.

An object of the disclosure is considered to be that of providing an absorber device having a hydraulic transmission, which is designed to be as space-saving and compact as possible.

The object is achieved in that the spring device comprises a first spring and a second spring, in that the absorber piston is mounted on the absorber piston rod so as to be axially movable, and in that the first spring and the second spring of the spring device are arranged on opposite sides of the absorber piston and in each case resiliently connect the absorber piston rod to the absorber piston such that the spring device counteracts a movement of the absorber piston in the axial direction, relative to the absorber piston rod.

The absorber device can be designed to be as space-saving and compact as possible. For this purpose, the spring device of the absorber device, which, in the prior art, is arranged in the axial extension of the hydraulic transmission, can be arranged in the hydraulic transmission and in this case in the interior space of the absorber housing that is filled with the hydraulic medium, wherein the absorber device can be designed to be space-saving, in particular in the axial direction.

In order to be able to effectively reduce the vibration of the vibratory component, the absorber piston is arranged not rigidly but rather movably on the absorber piston rod, such that a relative movement of the two components relative to one another can take place. In this case, the absorber piston rod can rest in a recess of the absorber piston, wherein said recess has the task, in addition to separating the first chamber from the second chamber, of guiding the absorber piston rod. In addition to the mounting of the absorber piston rod on the absorber piston, the absorber piston rod can be mounted in an opening on the absorber housing.

In this case, the absorber piston rod is preferably arranged on the absorber piston on mutually opposing sides, via the first and the second spring of the spring device, wherein the absorber piston is resiliently mounted on the absorber piston rod. In this case, the absorber piston rod protruding out of the absorber housing can be connected to the vibratory component, while the housing of the absorber device is connected to the quasi-static component. In this case, a force acting on the absorber piston rod along the axial direction can be reduced by the absorber device and converted into friction and ultimately into heat.

The spring device absorbs the force acting on the piston rod and is deformed in the process. In this case, the absorber piston rod can firstly-depending on the embodiment of the spring device—be moved relative to the absorber housing and deflect into the absorber housing, without triggering a movement of the absorber piston. The spring device can evade said force acting on it, and in the process move the absorber piston in parallel with the absorber piston rod and the acting force, inside the interior space. In this case, a pressure is applied by the absorber piston to the hydraulic medium in the second chamber of the absorber housing, wherein the hydraulic medium can flow via the hydraulic medium-conducting pressure compensation device from the second chamber into the first chamber. In this way, the pressure can be compensated and the force acting on the hydraulic medium via the absorber piston rod can be converted into heat by the friction of the hydraulic medium on the housing or on the pressure compensation device.

In this case, the interior space can be designed such that, even in the case of complete deflection of the absorber piston rod, there is still sufficient hydraulic medium available in the second chamber for effective damping of the force acting on the absorber piston rod. The displacement of the hydraulic medium by the spring device arranged in the interior space can be compensated by a corresponding dimensioning of the interior space, wherein for this purpose only a small change in size of the absorber housing has to be performed compared with an arrangement of the spring device outside the interior space.

According to an advantageous implementation, it is provided that the first spring and/or the second spring is a helical spring, wherein the absorber piston rod is resiliently mounted on the absorber piston via the first spring, on a first absorber piston side facing the first chamber, and via the second spring, on a second absorber piston side opposite the first absorber piston side and facing the second chamber. Mounting the absorber piston rod on both sides, via a helical spring in each case, on the absorber piston makes it possible for effective damping to be achieved in the case of vibrations of the vibratory system in both axial directions.

In addition to the embodiment of the first spring and the second spring of the spring device as helical springs, the first spring and/or the second spring can also be designed as disc springs, volute springs or annular springs, having different spring characteristics. Depending on the desired application, the embodiment of the first and of the second spring can be different from one another, wherein the two springs can have identical or different spring characteristics.

Advantageously, it is optionally provided that the first spring and the second spring are arranged opposingly to one another on the absorber piston. In this way, upon each deflection of the absorber piston rod one of the two springs is tensioned and the other of the two springs is compressed, such that the overall spring characteristic resulting from a superimposition of the respective spring characteristics can be specified identically for deflections in both directions.

In particular in the automotive field, for example during cornering transverse forces can act on the absorber device used, in a transverse direction to the axial direction. According to an advantageous embodiment, it is accordingly provided that the absorber piston rod is mounted in an axially movable manner on two absorber piston rod bearing regions that are arranged so as to be spaced apart from one another in the axial direction, such that the absorber piston rod can absorb transverse forced acting on the absorber piston rod in a transverse direction. In order to be able to absorb these transverse forces, the absorber piston rod can be mounted in an axially movable manner at two absorber piston rod mounting regions arranged spaced apart from one another. In this case, the absorber piston rod can be mounted at an opening of the housing wall of the absorber housing and in the recess of the absorber piston, or also at two openings on mutually opposing sides of the absorber housing. By mounting at both absorber piston rod bearing regions, both variants offer the possibility of being able to effectively absorb transverse forces arising.

It is also possible, and optionally provided, for the absorber device to have degressive spring characteristics. In the case of a deflection process of the absorber piston rod, degressive spring characteristics mean that the more the absorber piston rod deflects, the less force has to be applied for further deflection. As a result, in the case of a high action of force in the axial direction on the absorber piston rod, it is possible to achieve the absorber piston rod deflecting as deeply and quickly as possible, in order to reduce impacts or jolts during travel on an uneven substrate, and not transfer these to the vehicle body or to the occupants of the motor vehicle.

In addition to the design of the springs of the spring devices as helical springs, the spring device can also be designed as disc springs. Disc springs allow for degressive spring characteristics of the spring device.

It is preferably provided that the absorber piston comprises a sealing device, wherein the sealing device seals the absorber piston against the absorber housing and/or against the absorber piston rod in a fluid-tight manner. In order to allow an effective reduction of the forces acting on the absorber piston rod, the two chambers that are arranged in the interior space and formed by the absorber housing and the absorber piston rod are separated from one another as hermetically as possible. In this case, the pressure compensation preferably takes place only via the pressure compensation device, which interconnects the first chamber and the second chamber in a fluid-conducting manner. For this purpose, the sealing device can be designed as an elastomer seal and for example be arranged on an inner surface of the interior space, so as to cover the inner surface, such that the absorber piston rests on the inner surface in a fluid-tight but nonetheless movable manner. In addition, a further elastomer seal can be fixed on a lateral surface of the absorber piston. Furthermore, the absorber device can comprise an elastomer seal that lines the recess of the absorber piston, in order to seal the absorber piston against the absorber piston rod.

It is furthermore possible, and optionally provided, that the hydraulic medium-conducting pressure compensation device comprises a pipe portion that connects the first chamber to the second chamber, wherein the diameter of the first chamber and of the second chamber is larger than a diameter of the pipe portion. The hydraulic transmission makes it possible that the mass can be designed to be as light as possible, in terms of weight. In this case, the transmission ratio a is the quotient between a piston surface and a pipe portion surface. In this case, only the translation of the hydraulic medium leads to an increase in the inertia of the mass, which, in the case of a negligible mass of the piston, is in an order of magnitude of a⁻². The smaller the amount of hydraulic medium which can flow from the second chamber through the pipe portion and into the first chamber, the higher the inertia, in the case of an otherwise identically dimensioned system. In this case, the energy of the vibration is dissipated by the inert mass of the hydraulic medium that counteracts the vibration, by hydraulic losses, and by conversion into heat.

The pipe portion can be arranged on an end face of the absorber housing in each case, in parallel with the top and the bottom of the absorber piston, wherein the pipe portion in each case leads, with a pipe portion end, into the first and the second chamber, and connects said chambers in a hydraulic medium-conducting manner. In addition to this embodiment, the pipe portion can also be arranged on an inner wall in parallel with the absorber piston rod, wherein the absorber device is designed such that the absorber piston does not sweep over the pipe portion ends, being able to block the pressure compensation device in the process, in the case of a movement in the interior space. The pipe portion can also be arranged in the absorber piston, wherein one or more pipe portions connect the top of the absorber piston to the bottom, in a hydraulic medium-conducting manner.

In an advantageous embodiment, it is provided that the hydraulic medium is mineral oil. In addition to the use of a hydraulic medium based on mineral oil, the hydraulic medium used can also be a silicone oil or an acid ester.

The disclosure also relates to a damper device for damping a force acting on a damper device, wherein the damper device comprises a damper housing, which encloses an interior space and has a hydraulic medium, and comprises a damper piston rod, which has a damper piston fixed thereon, wherein the damper piston is arranged in the interior space and divides said interior space into a first chamber and a second chamber, wherein the damper piston rod is movable in an axial direction, relative to the damper device housing, such that in the event of action of a force on the damper piston rod a movement of the damper piston rod along an axial direction, relative to the housing, is made possible, wherein upon movement of the damper piston rod the damper piston is moved and a pressure is applied to the hydraulic medium of the second chamber by the damper piston, and the pressure is compensated via a hydraulic medium-conducting pressure compensation device that connects the second chamber to the first chamber.

In order to reduce vibrations of a vibratory component, on the one hand absorber devices and on the other hand damper devices can be used. Absorber devices are designed to displace the occurring energy, in order to counteract a resonance in the natural frequency. In contrast to absorber devices, which are fastened to the vibratory component and are used to reduce vibrations by matching the natural frequency of the absorber device to the resonant frequency, to be eliminated, of the vibratory system, damper systems are used to damp vibrations independently of frequency, and to dissipate the energy absorbed in the process.

Single pipe damper devices and twin pipe damper devices are known from practice. The two embodiments have in common the fact that, in the case of a movement of the damper piston relative to the damper housing, a pressure is applied to the hydraulic medium, which medium flows in this case from one chamber into another chamber, and in the process the withdraws energy from the movement of the damper piston by friction of the hydraulic medium on the damper housing.

In order to be able to combine the advantages of a frequency-dependent absorber device and a frequency-independent damper device, variants are known from practice, wherein a damper device and an absorber device are connected one behind the other in parallel, along an axial direction. However, lining up on the one hand the absorber device and on the other hand the damper device places significant demands on the space requirement, in particular in the axial direction.

An object of the disclosure is considered to be that of combining a damper device and an absorber device in as space-saving a manner as possible.

The object is achieved in that the damper piston rod is hollow, at least in portions, and that an absorber device having the features described above is arranged in the hollow damper piston rod. In this case, the absorber device can be arranged in a space-saving manner in the hollow damper piston rod, and does not, as in the case of conventional damper/absorber combinations, have to be designed as an arrangement of a damper device and an absorber device behind one another in the axial direction. Thus, the absorber device can be connected to the damper device by the movement into the hitherto unused region inside the damper piston rod, wherein this can be inserted into the damper piston rod as one unit. This allows for a space-saving and compact design of a damper/absorber combination. In this case, the absorbing effect, i.e. a reduction of the vibration of two components relative to one another, can be designed to be frequency-independent or frequency-dependent. The damper piston rod can be arranged on the vibratory component and the absorber piston rod on the quasi-static component, or vice versa.

It is also possible, and optionally provided, for the absorber device to be fixed on the damper device housing via the absorber piston rod. This makes it possible for the absorber device to be connected to the vibratory component via the absorber piston rod, such that forces acting on the damper housing can be transmitted directly to the absorber device.

It is preferably provided that the pressure compensation device is arranged between the absorber housing and the damper piston rod. In this case, the pressure compensation device can be formed as a gap extending between an outside of the absorber housing and an inside of the damper piston rod.

In an alternative embodiment, the pressure compensation device is a helical groove formed on an outside of the absorber housing. In this case, a helical channel is formed when the absorber device is arranged in the damper piston rod. The helical embodiment of the pressure compensation device makes it possible for the energy of the hydraulic medium flowing through the helical channel to be converted quickly and efficiently into heat, by means of friction. An embodiment of this kind, having a groove made in the outside, is furthermore simple and cost-effective to implement, wherein the absorber housing can be made from a commercially available round steel.

Further advantageous embodiments of the absorber device and the damper device are explained on the basis of embodiments shown in the drawings.

### BRIEF DESCRIPTION OF THE DRAWINGS

FIG. 1 shows an absorber device from the prior art, wherein a spring device is arranged on a hydraulic transmission.

FIG. 2 shows an absorber device according to the disclosure, wherein the spring device is arranged in an interior space of the absorber device.

FIG. 3 shows an embodiment of the absorber device as a chassis component of a motor vehicle.

FIG. 4 is an enlarged view of an absorber piston and of the spring device from FIG. 3.

FIG. 5 shows a damper device with an absorber device arranged in a hollow damper piston rod.

FIG. 6 is a detailed view of the absorber device from FIG. 5.

FIG. 7 is an enlarged view of an absorber housing from FIG. 6.

### DETAILED DESCRIPTION

Conventionally, an absorber device 1 comprises a spring device/mass system, wherein the mass or the inertia of the absorber device 1 is connected to a vibratory system via the spring device. The natural frequency of the absorber device 1 is matched to the resonant frequency, to be eliminated, of the vibratory system. Therefore, at this frequency, during use of an absorber device 1 matched thereto, smaller movements triggered by the vibrations occur, wherein the generation of vibrations of the absorber device 1 withdraws energy from the vibratory system.

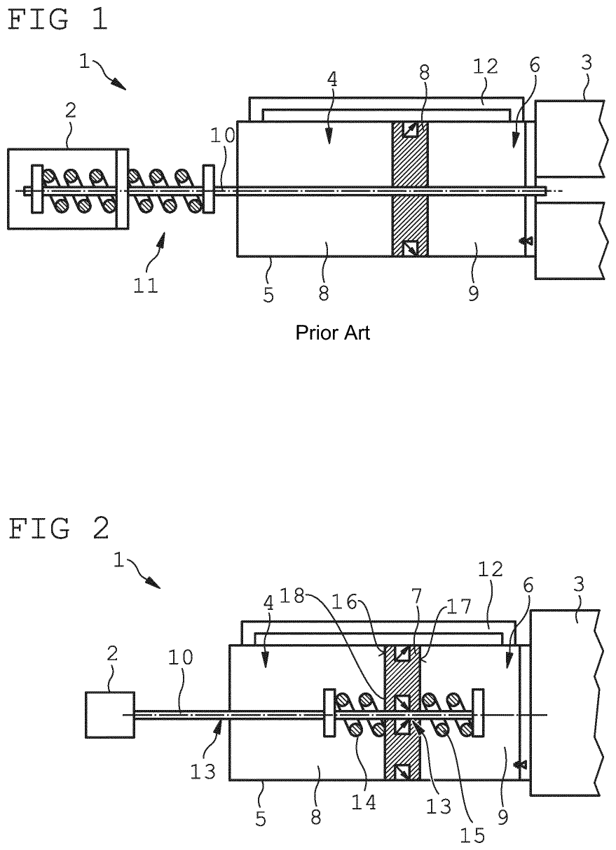

FIG. 1 shows a known design of an absorber device 1 having a hydraulic connection for reducing occurring vibrations between a quasi-static component 2 and a vibratory component 3, from the prior art. The absorber device 1 comprises an absorber housing 5, which encloses an interior space 4 and has a hydraulic medium 6 arranged in the interior space 4. An absorber piston 7 divides the interior space 4 into a first chamber 8 and a second chamber 9. Furthermore, an absorber piston rod 10 protrudes from one side into the interior space 4, wherein the absorber piston rod 10 is rigidly fixed on the absorber piston 7. The absorber piston rod 10 and the absorber piston 7 are arranged so as to be movable relative to the absorber housing 5, in an axial direction. Furthermore, the absorber device 1 comprises a spring device 11 which is designed as a spring and is arranged on the absorber piston rod 10. In the event of action of a force on the absorber piston rod 10 along the axial direction, with a force greater than a spring force of the spring device 11, the absorber piston rod 10 is moved along the axial direction, relative to the absorber housing 5. In the case of this movement of the absorber piston rod 10, the absorber piston 7, rigidly connected to the absorber piston rod 10, is also moved in parallel with the absorber piston rod 10, and a pressure is applied to the hydraulic medium 6 from the second chamber 9 by the absorber piston 7. This occurring pressure is compensated by a pressure compensation device 12 which connects the second chamber 9 to a first chamber 8 and is designed as a pipe portion. However, this known possible embodiment has the disadvantage that, in particular in the axial direction, a compact design is not possible due to the spring device and hydraulic transmission that are arranged so as to follow one behind the other in the axial direction.

FIG. 2 is a sectional view of an embodiment of an absorber device 1, which allows for a compact design due to the arrangement of the spring device 11. The absorber device 1 comprises the absorber housing 5, which encloses an interior space 4 and has a hydraulic medium 6 arranged in the interior space 4, and the absorber piston rod 7 having the absorber piston 10. The absorber piston 7 divides the interior space 4, in a fluid-tight manner, into the first chamber 8 and the second chamber 9. In this case, the absorber piston rod 7 protruding into the interior space 4 rests on the absorber housing 5 in an absorber piston rod bearing region 13 (not shown in greater detail in the figures), and in a recess of the absorber piston 7 that is designed as an absorber piston rod bearing region 13 and is arranged centrally. The mounting on the two absorber piston rod bearing regions 13 that are arranged so as to be spaced apart from one another makes it possible for the absorber piston rod 10, for example in the case of cornering of a motor vehicle, to effectively absorb occurring transverse forces.

The absorber piston 7 is fixed on the absorber piston rod 10 via the spring device 11. For this purpose, the spring device 11 comprises a first spring 14 and a second spring 15, wherein the two springs 14, 15 are in each case designed as helical springs. The absorber piston rod 10 is resiliently mounted on the absorber piston 10 via the first spring 14, on a first absorber piston side 16 facing the first chamber 8, and via the second spring 15, on a second absorber piston side 17 opposite the first absorber piston side 16 and facing the second chamber 9.

For an effective fluid-tight separation of the first chamber 8 and the second chamber 9, the absorber piston 7 comprises, on its lateral surface, a sealing device 18 designed as an elastomer coating. A further elastomer coating that lines the recess of the absorber piston 7 seals the absorber piston rod 10 against the absorber piston 7 in a fluid-tight manner, wherein a relative movement of the two parts is made possible. In order to be able to effectively reduce a vibration of the vibratory component, the absorber piston 7 is arranged not rigidly but rather movably on the absorber piston rod 10, such that a relative movement of the two components relative to one another can take place.

In this case, the absorber piston rod 10 protruding out of the absorber housing 5 can be connected to the vibratory component 2, while the absorber housing 5 is connected to the quasi-static component 3. In this case, a force acting on the absorber piston rod 10 along the axial direction can be reduced by the absorber device 1 and converted into friction and ultimately into heat. The spring device 11 absorbs the force between the piston 7 and the piston rod 10 and is deformed in the process. In this case, the absorber piston rod 10 can firstly be moved relative to the absorber housing 5 and deflect into the absorber housing 5, without triggering a movement of the absorber piston 7. The spring device 11 can evade said force acting on it, and in the process move the absorber piston 7 in parallel with the absorber piston rod 10 and the acting force, inside the interior space 4. In this case, a pressure is applied by the absorber piston 7 to the hydraulic medium 6 in the second chamber 9 of the absorber housing 5, wherein the hydraulic medium 6 can flow via the hydraulic medium-conducting pressure compensation device 12 from the second chamber 9 into the first chamber 8. In this way, the pressure can be compensated and the force acting on the absorber piston rod 10 can be converted into heat by the friction of the hydraulic medium 6 on the absorber housing 5 or on the pressure compensation device 12. In the case of the natural frequency of the absorber device 1, the forces brought about on the absorber piston 7 by the inertia of the hydraulic medium 6 counteract the forces acting on the absorber piston rod 10.

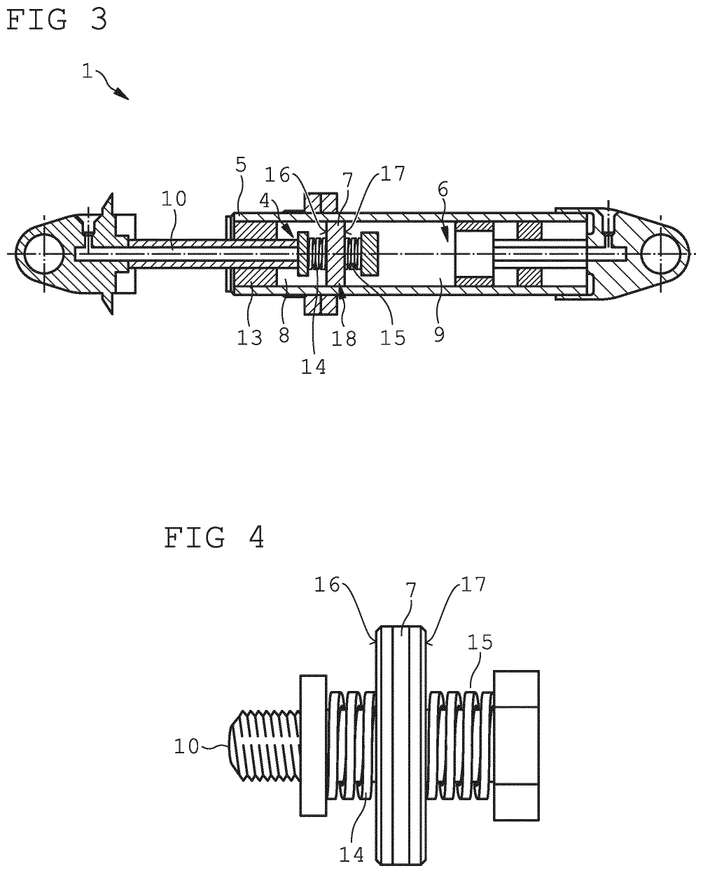

FIG. 3 is a sectional view of an embodiment of the absorber system 1, wherein in this variant the absorber system 1 can be used as a chassis component, in addition to a body spring (not shown here). In this case, the operating principle corresponds to the function described in FIG. 2, wherein here the first spring 14 and the second spring 15 are designed as disc springs, and the absorber device thus has degressive spring characteristics. FIG. 4 is an enlarged view of the structure of the absorber piston 7 and the spring device 11 from FIG. 3.

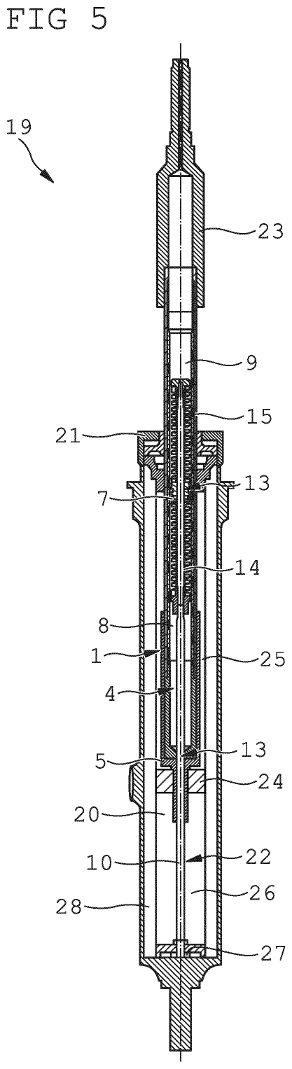

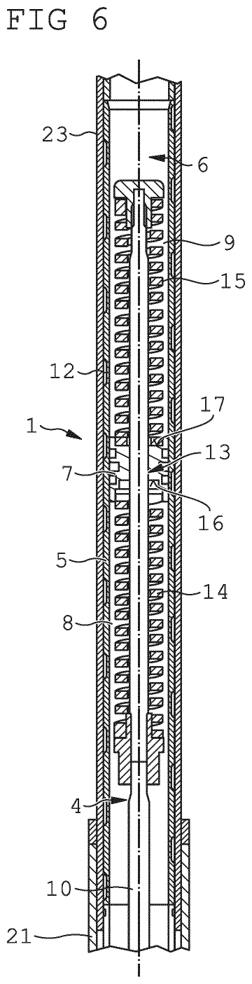

FIG. 5 is a sectional view of an embodiment of a damper device 19 together with an absorber device 1. In this case, the damper device 19 is designed as a twin pipe damper. It comprises a damper housing 21, which encloses an interior space 20 and has a hydraulic medium 22 arranged in the interior space 20, and comprises a damper piston rod 23, which has a damper piston 24 fixed thereon. The damper piston 24 arranged in the interior space 20 divides said interior space into a first chamber 25 and into a second chamber 26, wherein the damper piston rod 23 is movable in an axial direction, relative to the damper housing 21.

In the case of a force acting on the damper piston rod 23, said damper piston rod is moved along an axial direction relative to the damper housing 21, wherein upon movement of the damper piston rod 23 the damper piston 24 is moved and a pressure is applied to the hydraulic medium 22 of the second chamber 26 by the damper piston 24, and the pressure is compensated via a hydraulic medium-conducting damper pressure compensation device, in the damper piston 24, that connects the second chamber 26 to the first chamber 25, and by a damper compensation space 28 that is connected to the second chamber 26 via a damper non-return valve 27. In this case, the force acting on the damper device 20 is converted, by the hydraulic medium 22, into movement and ultimately into heat, and thus energy is withdrawn from the vibratory system.

In this case, the damper device 20 allows for frequency-independent camping of the vibration. In order to additionally achieve a frequency-dependent reduction in the vibrations, the absorber device 1 is arranged in the hollow damper piston rod 23. The absorber device 1 is fixed on the damper non-return valve 27 via the absorber piston rod 10. The absorber device 1 is thus connected to the vibratory component 2 via the absorber piston rod 10 since forces acting on the damper housing 21 can be transmitted to the absorber device 1 via the damper non-return valve 27. The damper piston rod 23 can furthermore be connected to the quasi-static component 3.

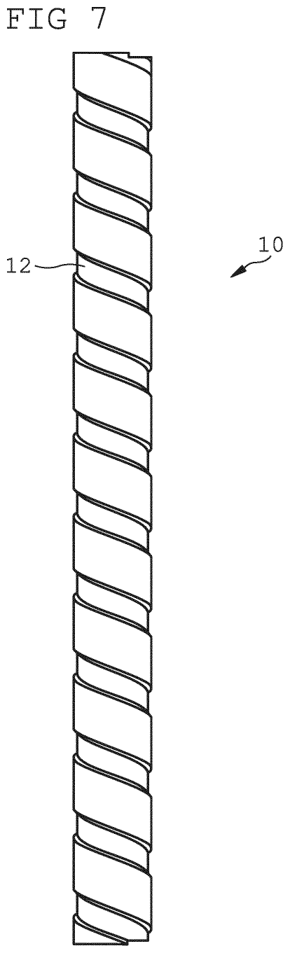

FIG. 6 is an enlarged view of the damper piston rod 23 with the absorber device 1 arranged therein, from FIG. 7. In this case, the pressure compensation device 12 is designed as a helical groove arranged on an outside of the absorber housing 5. In the case of the arrangement of the absorber device 1 in the damper piston rod 23, a helical channel is formed, which connects the second chamber 9 to the first chamber 8 in a hydraulic medium-conducting manner. In this case, FIG. 7 shows the helical groove on the outside of the absorber housing 5.

### LIST OF REFERENCE SIGNS

1 ABSORBER DEVICE
2 VIBRATORY COMPONENT
3 QUASI-STATIC COMPONENT
4 INTERIOR SPACE OF THE ABSORBER DEVICE
5 ABSORBER HOUSING
6 HYDRAULIC MEDIUM OF THE ABSORBER DEVICE
7 ABSORBER PISTON
8 FIRST CHAMBER OF THE ABSORBER DEVICE
9 SECOND CHAMBER OF THE ABSORBER DEVICE
10 ABSORBER PISTON ROD
11 SPRING DEVICE
12 PRESSURE COMPENSATION DEVICE
13 ABSORBER PISTON ROD BEARING REGION
14 FIRST SPRING
15 SECOND SPRING
16 FIRST ABSORBER PISTON SIDE
17 SECOND ABSORBER PISTON SIDE
18 SEALING DEVICE
19 DAMPER DEVICE
20 INTERIOR SPACE OF THE DAMPER DEVICE
21 DAMPER HOUSING
22 HYDRAULIC MEDIUM OF THE DAMPER DEVICE
23 DAMPER PISTON ROD
24 DAMPER PISTON
25 FIRST CHAMBER OF THE DAMPER DEVICE
26 SECOND CHAMBER OF THE DAMPER DEVICE
27 DAMPER NON-RETURN VALVE
28 DAMPER COMPENSATION SPACE

1.-12. (canceled)

13. An absorber device (1) for absorbing a force acting thereon, comprising:
an absorber housing (5) which encloses an interior space (4);
a hydraulic medium (6) arranged in the interior space (4); and
an absorber piston rod (10) which has an absorber piston (7) arranged thereon,
wherein the absorber piston rod (10) is arranged so as to protrude into the interior space (4) along an axial direction relative to the absorber housing (5),
wherein the absorber piston (7) is arranged in the interior space (4) and divides the interior space into a first chamber (8) and a second chamber (9),
wherein the absorber device (1) comprises a spring device (11) for resiliently supporting the absorber piston (7) relative to a quasi-static component (2),
wherein upon movement of the absorber piston rod (10) the absorber piston (7) is moved and a pressure is applied to the hydraulic medium (6) of the second chamber (9) by the absorber piston (7), and
wherein the pressure is compensated via a hydraulic medium-conducting pressure compensation device (12) that connects the second chamber (9) to the first chamber (8),
wherein the spring device (11) comprises a first spring (14) and a second spring (15),
wherein the absorber piston (7) is mounted on the absorber piston rod (10) so as to be axially movable, and
wherein the first spring (14) and the second spring (15) of the spring device (11) are arranged on opposite sides of the absorber piston (7) and in each case resiliently connect the absorber piston rod (10) to the absorber piston (7) such that the spring device (11) counteracts a movement of the absorber piston (7) in the axial direction, relative to the absorber piston rod (10).

14. The absorber device (1) according to claim 13,
wherein the first spring (14) and/or the second spring (15) is a helical spring,
wherein the absorber piston rod (10) is resiliently mounted on the absorber piston (7) via the first spring (14), on a first absorber piston side (16) facing the first chamber (8), and via the second spring (15), on a second absorber piston side (17) opposite the first absorber piston side (16) and facing the second chamber (9).

15. The absorber device (1) according to claim 13,
wherein the first spring (14) and the second spring (15) are arranged opposingly to one another on the absorber piston (7).

16. The absorber device (1) according to claim 13,
wherein the absorber piston rod (9) is mounted in an axially movable manner on two absorber piston rod bearing regions (13) that are arranged so as to be spaced apart from one another in the axial direction, such that the absorber piston rod (10) can absorb transverse forces acting on the absorber piston rod (10) in a transverse direction.

17. The absorber device (1) according to claim 13,
wherein the absorber device (1) has degressive spring characteristics.

18. The absorber device (1) according to claim 13,
wherein the absorber piston (7) comprises a sealing device (18),
wherein the sealing device (18) seals the absorber piston (7) in a fluid-tight manner against the absorber housing (5) and/or against the absorber piston rod (10).

19. The absorber device (1) according to claim 13,
wherein the hydraulic medium-conducting pressure compensation device (12) comprises a pipe portion that connects the first chamber (8) to the second chamber (9),
wherein a diameter of the first chamber (8) and of the second chamber (9) is larger than a diameter of the pipe portion.

20. The absorber device (1) according to claim 13,
wherein the hydraulic medium (6) is a mineral oil.

21. A damper device (19) for damping a force acting thereon, comprising:
a damper housing (21) which encloses an interior space (20);
a hydraulic medium (22) arranged in the interior space (20);
a damper piston rod (23) which has a damper piston (22) fixed thereon,
wherein the damper piston (22) is arranged in the interior space (20) and divides the interior space into a first chamber (25) and a second chamber (26),
wherein the damper piston rod (23) is movable in an axial direction, relative to the damper housing (21), such that in an event of action of a force on the damper piston rod (23) a movement of the damper piston rod (23) along the axial direction, relative to the damper housing (21), is made possible,
wherein upon movement of the damper piston rod (23) the damper piston (24) is moved and a pressure is applied to the hydraulic medium (22) of the second chamber (26) by the damper piston (24), and the pressure is compensated via a hydraulic medium-conducting damper pressure compensation device that connects the second chamber (26) to the first chamber (25),
wherein the damper piston rod (23) is hollow at least in portions, and
wherein the absorber device (1) according to claim 13 is arranged in the damper piston rod (23).

22. The damper device (19) according to claim 21,
wherein the absorber device (1) is fixed on the damper housing (21) via the absorber piston rod (10).

23. The damper device (19) according to claim 21,
wherein the pressure compensation device (12) is arranged between the absorber housing (5) and the damper piston rod (23).

24. The damper device (19) according to claim 21,
wherein the pressure compensation device (12) is a helical groove formed on an outside of the absorber housing (5).
